(19) United States
(12) Patent Application Publication
(10) Pub. No.: US 2024/0293279 A1
(43) Pub. Date: Sep. 5, 2024

(54) MODULAR AND PORTABLE PLUG-AND-TRAIN ROBOT FOR PROVIDING HAND REHABILITATION

(71) Applicants: INDIAN INSTITUTE OF TECHNOLOGY MADRAS (IIT MADRAS), Chennai (IN); CHRISTIAN MEDICAL COLLEGE, Vellore (IN)

(72) Inventors: Sujatha Srinivasan, Chennai (IN); Aravind Nehrujee, Vellore (IN); Sivakumar Balasubramanian, Pondicherry (IN)

(73) Assignees: Indian Institute of Technology Madras (IIT Madras), Chennai (IN); Christian Medical College (CMC Vellore), Vellore (IN)

(21) Appl. No.: 18/562,611

(22) PCT Filed: Feb. 10, 2022
(86) PCT No.: PCT/IN2022/050115

§ 371 Date: Nov. 20, 2023

(30) Foreign Application Priority Data
May 21, 2021 (IN) 202141022805

(51) Int. Cl. A61H 1/02

(52) U.S. Cl. CPC A61H 1/0288; A61H 2201/0107; A61H 2201/0157; A61H 2201/1215; A61H 2201/1635; A61H 2201/5007; A61H 2201/5061

(57) ABSTRACT

Embodiments herein provide a modular and portable plug-and-train robot (1000) for providing hand rehabilitation. The modular and portable plug-and-train robot (1000) includes a housing (100) and a power source (200) for powering the modular and portable plug-and-train robot (1000) to provide the hand rehabilitation. The modular and portable plug-and-train robot (1000) also includes an actuator (300) mounted within the housing (100) and connected to the power source (200) for providing movements to the modular and portable plug-and-train robot (1000). Then the modular and portable plug-and-train robot (1000) includes a plug-in apparatus (400) for coupling the actuator (300) and a therapy tool (500) and an instrumented armrest (600) connected to the housing (100) for determining compensatory forces applied by a forearm of the user during the hand rehabilitation. The therapy tool (500) provides a single DOF movement to a hand for the hand rehabilitation.

### FIELD OF INVENTION

The embodiments herein relate to modular and portable devices. More particularly relates to a modular and portable plug-and-train robot for providing hand rehabilitation using a single actuator along with various therapy tools by a plug and train mechanism.

### BACKGROUND OF THE INVENTION

In general, a plurality of medical conditions such as for example congenital causes, trauma, tumors, stroke, etc., may lead to weakening or paralysis of one or both hands of a user. The user may not able to perform daily activities independently and thus have to rely on human assistance for basic activities of daily living like feeding, self-care, and mobility. Improvements in hand function, in general, require therapy with graded difficulty through different exercises focused on strength, range of motion, and coordination. However, complexity and versatility of the hand needs to be taken into consideration before providing the therapy.

With advancement in technology, various robots are used for providing hand rehabilitation. The repetitive nature of the therapy makes the therapy amenable to administration by intricately designed robots. However, conventional rehabilitation robots used for training the hands of the user require either several simple robots to train different hand functions individually or one very complex robot capable of training all hand functions individual or simultaneously, which may makes this form a solution expensive and unsuitable for clinical adoption. Multiple simple robots or a single complex robot for hand training makes the current solution for hand therapy bulky, non-portable, and cannot be easily taken to the user for providing the hand rehabilitation. Therefore, the existing rehabilitation robots are not cost effective and adaptable to the users.

Thus, it is desired to address the above mentioned disadvantages or other shortcomings or at least provide a useful alternative.

### OBJECT OF INVENTION

The principal object of the embodiments herein is to provide a highly modular and portable plug-and-train robot which can be moved close to a patient in a bed or a wheelchair for providing hand rehabilitation using a single actuator and various passive therapy tools by a plug and train mechanism. Therefore, the hand rehabilitation training of a multitude of hand functions can be initiated using the modular and portable plug-and-train robot at an early stage for patients who have suffered conditions such as hand paralysis.

Another object of the embodiments herein is to provide various wrist movements and hand movements to the patient using a variety of therapy tools for providing the hand rehabilitation.

### SUMMARY

Accordingly, the embodiments herein provide a modular and portable plug-and-train robot for providing hand rehabilitation. The modular and portable plug-and-train robot includes a memory, a processor, housing and a power source for powering the modular and portable plug-and-train robot to provide the hand rehabilitation. The modular and portable plug-and-train robot also includes an actuator mounted within the housing and connected to the power source for providing movements to different therapy tools attached to the robot. The modular and portable plug-and-train robot also includes a plug-in apparatus for coupling the actuator and a passive therapy tool and an instrumented armrest connected to the housing for determining compensatory forces applied by a forearm of the user during the hand rehabilitation. The therapy tool provides a single degree of freedom (DOF) movement to a hand for the hand rehabilitation.

In an embodiment, the actuator is a gearless direct current (DC) motor.

In an embodiment, the therapy tool provides training to the hand in order to induce at least one of wrist movements, and hand (fingers and thumb) movements.

In an embodiment, the therapy tool comprises one of an armature hub and a plunger to connect at a top portion of the plug-in apparatus.

In an embodiment, the plug-in apparatus is one of an electromagnetic clutch, a mechanical shutter lock and a Bowden Cable mechanism, wherein the electromagnetic clutch uses an electromagnetic force to connect the therapy tool to the actuator.

In an embodiment, the mechanical shutter lock comprises a motor shaft coupler, a spring and a lock-pin, wherein the lock-pin comprises a profile matched with the plunger of the therapy tool.

In an embodiment, the spring in the mechanical shutter lock pushes the lock-in against the plunger of the therapy tool to lock the plunger in a specific position and the locked plunger couples the therapy tool with the motor shaft coupler of the mechanical shutter lock, wherein the motor shaft coupler rotates and transfers the rotation to the therapy tool.

In an embodiment, the electromagnetic clutch comprises a bearing mounted rotor assembly to which the actuator is coupled through an L-plate, wherein the actuator is mounted to the L-plate with an anti-rotation pin.

In an embodiment, the actuator with a hall sensor to measure a speed of the actuator and an encoder to measure an angular position of the actuator is attached to a bottom portion of the L-plate.

In an embodiment, the bearing mounted rotor assembly is magnetically coupled to the armature hub of the therapy tool to transfer a rotation of the actuator to operate the therapy tool.

In an embodiment, the instrumented armrest is connected to the housing using a plate arrangement and wherein the plate arrangement comprises a load cell assembly to measure the compensatory forces applied on the armrest by the forearm of the user during the hand rehabilitation, wherein the compensatory forces comprises vertical forces and lateral forces.

In an embodiment, the instrumented armrest comprises a first force transducer placed on a bottom portion of the instrumented armrest to measure the vertical forces applied by the forearm of the user, and a second force transducer placed on a left portion and a right portion of the instrumented armrest to measure the lateral forces applied by the forearm of the user.

In an embodiment, the compensatory force measured by the instrumented armrest is used for real-time modification of the hand rehabilitation.

In an embodiment, the therapy tool is attached to the hand of the user and connected to an intermediate base, wherein the intermediate base is connected to the plug-in apparatus.

In an embodiment, the wrist movements and hand movements comprises at least one of a wrist flexion-extension, a wrist ulnar-radial deviation, a Forearm pronation-supination, a gross hand opening and closing movement, an instrumented hand opening-closing, a tripod pinch, a thumb flexion-extension, a Finger stretching and Individual finger flexion-extension and abduction-adduction training mechanism.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the scope thereof, and the embodiments herein include all such modifications.

### BRIEF DESCRIPTION OF FIGURES

This invention is illustrated in the accompanying drawings, throughout which like reference letters indicate corresponding parts in the various figures. The embodiments herein will be better understood from the following description with reference to the drawings, in which:

FIG. 1 is a block diagram of a modular and portable plug-and-train robot for providing hand rehabilitation, according to the embodiments as disclosed herein;

FIG. 2A is a tabletop design of the modular and portable plug-and-train robot for providing the hand rehabilitation with electromagnetic clutch as a plug-in apparatus, according to the embodiments as disclosed herein;

FIG. 2B illustrates an assembly of the electromagnetic clutch as the plug-in apparatus of the modular and portable plug-and-train robot, according to the embodiments as disclosed herein;

FIG. 2C illustrates a torque characterization setup of the electromagnetic clutch, according to the embodiments as disclosed herein;

FIG. 2D illustrates a surface temperature of the electromagnetic clutch, according to the embodiments as disclosed herein;

FIG. 3 illustrates an assembly of a mechanical shutter lock as plug-in apparatus of the modular and portable plug-and-train robot, according to the embodiments as disclosed herein;

FIGS. 4A-4B illustrates an assembly of a Bowden cable as plug-in apparatus of the modular and portable plug-and-train robot, according to the embodiments as disclosed herein;

FIG. 4C illustrates the assembly of a Bowden with a motor of the modular and portable plug-and-train robot, according to the embodiments as disclosed herein;

FIG. 5A and FIG. 5B are examples of attaching the therapy tools used to provide a wrist flexion-extension and a wrist ulnar-radial deviation mechanism hand rehabilitation using the electromagnetic clutch and mechanical shutter lock respectively, to the modular and portable plug-and-train robot, according to the embodiments as disclosed herein;

FIG. 6A and FIG. 6B are an examples of attaching the therapy tool used to provide a forearm pronation-supination hand rehabilitation using the electromagnetic clutch and the mechanical shutter lock respectively, to the modular and portable plug-and-train robot, according to the embodiments as disclosed herein;

FIG. 7A and FIG. 7B are an example of attaching the therapy tool used to provide a Gross hand opening-closing hand rehabilitation using the electromagnetic clutch and the mechanical shutter lock respectively, to the modular and portable plug-and-train robot, according to the embodiments as disclosed herein;

FIG. 8A and FIG. 8B are examples of attaching the therapy tool used to provide an instrumented hand opening closing hand rehabilitation using the electromagnetic clutch and the mechanical shutter lock respectively, to the modular and portable plug-and-train robot, according to the embodiments as disclosed herein;

FIG. 9A and FIG. 9B are examples of attaching the therapy tool used to provide a tripod pinch hand rehabilitation using the electromagnetic clutch and the mechanical shutter lock respectively, to the modular and portable plug-and-train robot, according to the embodiments as disclosed herein;

FIG. 10A and FIG. 10B are examples of attaching the therapy tool used to provide a thumb flexion-extension hand rehabilitation using the electromagnetic clutch and the mechanical shutter lock respectively, to the modular and portable plug-and-train robot, according to the embodiments as disclosed herein;

FIG. 11A and FIG. 11B are examples of attaching the therapy tool used to provide a finger stretching hand rehabilitation using the electromagnetic clutch and the mechanical shutter lock respectively, to the modular and portable plug-and-train robot, according to the embodiments as disclosed herein;

FIG. 12A and FIG. 12B are examples of attaching the therapy tool used to provide a Metacarpophalangeal joint (MCP) finger stretching hand rehabilitation using the electromagnetic clutch and the mechanical shutter lock respectively, to the modular and portable plug-and-train robot, according to the embodiments as disclosed herein;

FIG. 13 illustrates an instrumented armrest for determining compensatory forces applied by a forearm of the user during the hand rehabilitation, according to the embodiments as disclosed herein;

FIG. 14 illustrates camera integration to the hand rehabilitation provided by the modular and portable plug-and-train robot, according to the embodiments as disclosed herein;

FIG. 15 illustrates an emergency switch incorporated with the modular and portable plug-and-train robot for providing the hand rehabilitation, according to the embodiments as disclosed herein; and

FIG. 16A-16C illustrates a trolley design incorporating the modular and portable plug-and-train robot with a wheelchair, according to the embodiments as disclosed herein.

### DETAILED DESCRIPTION OF INVENTION

Various embodiments of the present disclosure will now be described in detail with reference to the accompanying drawings. In the following description, specific details such as detailed configuration and components are merely provided to assist the overall understanding of these embodiments of the present disclosure. Therefore, it should be apparent to those skilled in the art that various changes and modifications of the embodiments described herein can be made without departing from the scope of the present disclosure. In addition, descriptions of well-known functions and constructions are omitted for clarity and conciseness.

Also, the various embodiments described herein are not necessarily mutually exclusive, as some embodiments can be combined with one or more other embodiments to form new embodiments.

Herein, the term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

Accordingly, the embodiments herein provide a modular and portable plug-and-train robot for providing hand rehabilitation. The modular and portable plug-and-train robot includes a memory, a processor, housing and a power source for powering the modular and portable plug-and-train robot to provide the hand rehabilitation. The modular and portable plug-and-train robot also includes an actuator mounted within the housing and connected to the power source for providing movements to the modular and portable plug-and-train robot. The modular and portable plug-and-train robot also includes a plug-in apparatus for coupling the actuator and a therapy tool and an instrumented armrest connected to the housing for determining compensatory forces applied by a forearm of the user during the hand rehabilitation. The therapy tool provides a single degree of freedom (DOF) movement to a hand for the hand rehabilitation.

Conventional robots while training between pronation and superannuation or between flexion extensions needs to be rotated or modified to be able to provide the requisite therapy which makes it difficult to use the conventional robot. Unlike the conventional robots, the proposed modular and portable plug-and-train robot only requires the therapy tool to be changed for training the various movements of the hand. Therefore, the proposed modular and portable plug-and-train robot is easy to be used and can provide therapy to bring about multiple movements of the hand individually.

Unlike to the conventional robots, the proposed modular and portable plug-and-train robot uses an electromagnetic clutch to attach and detach the therapy tools which provides easy plug-in of the therapy tool to the actuator. As a result, the proposed modular and portable plug-and-train robot is a compact tool with a high benefit-to-cost ratio for both in-clinic and home-based hand rehabilitation.

Conventional robots used for providing the hand rehabilitation use multiple actuators to train for multiple functions of the hand which makes the conventional robots bulky and costly. Unlike to the conventional robots, the proposed modular and portable plug-and-train robot uses a single actuator with multiple therapy tools which can be easily attached and detached to the modular and portable plug-and-train robot. Hence, the proposed modular and portable plug-and-train robot is cost effective and can be easily moved due to the high portability.

Unlike the conventional robots, the proposed modular and portable plug-and-train robot also provides the instrumented armrest to track compensatory forces applied by the forearm of the user during the hand rehabilitation training. This enables the medical practitioner/trainer to modify the therapy and behavior of the user to provide better and effective hand rehabilitation.

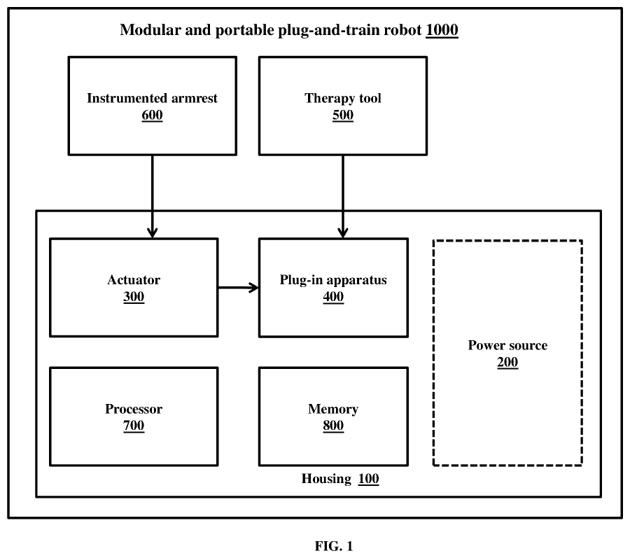

Referring now to the drawings, and more particularly to FIGS. 1 through 16C, where similar reference characters denote corresponding features consistently throughout the figures, there are shown preferred embodiments.

FIG. 1 is a block diagram of a modular and portable plug-and-train robot (1000) for providing hand rehabilitation, according to the embodiments as disclosed herein.

Referring to the FIG. 1, the modular and portable plug-and-train robot (1000) includes housing (100) which houses a power source (200), an actuator (300), a plug-in apparatus (400), a processor (700) and a memory (800). The modular and portable plug-and-train robot (1000) also includes a therapy tool (500) and an instrumented armrest (600).

In an embodiment, the power source (200) is used to power a motor of the actuator (300). The power source (200) may be a battery which is in-built into the modular and portable plug-and-train robot (1000) or an external power connection.

In an embodiment, the actuator (300) transfers a rotation of a motor to a rotor which generates an electromagnetic field. The electromagnetic field allows the plug-in apparatus (400) to be attached to the actuator (300) and the therapy tool (500) can be connected to the plug-in apparatus (400). The actuator (300) is for example but not limited to a gearless direct current (DC) motor. The actuator (300) is integrated with a hall sensor and an encoder to measure a speed and angular position, respectively. An actuator current is sensed and is used to estimate a torque applied by the motor.

In an embodiment, the plug-in apparatus (400) is used as an intermediate device used to connect the therapy tool (500) to the actuator (300). The plug-in apparatus (400) is partly within the housing (100) and has a circular opening on top where the therapy tool (500) is to be attached. The plug-in apparatus (400) is for example but not limited to an electromagnetic clutch, a mechanical shutter lock or a Bowden cable.

In an embodiment, the therapy tool (500) is designed to provide specific type training to bring about the hand rehabilitation. The therapy tools (500) can be either an active therapy tool or a passive therapy tool. The active therapy tool includes sensors and is powered through the power source (200).

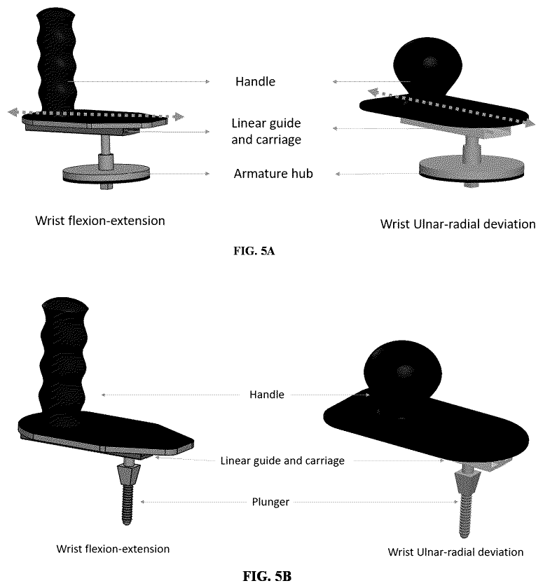

Each of the therapy tools (500) includes an armature hub or a plunger at a bottom portion to attach the therapy tool (500) to the actuator (300) through the plug-in apparatus (400). When the plug-in apparatus (400) is the electromagnetic clutch then the therapy tool (500) needs to have the armature hub and when the plug-in apparatus (400) is the mechanical shutter lock then the therapy tool (500) needs to have the plunger. The therapy tool (500) is provided to train the user in wrist movements and hand movements which includes but are not limited to a wrist flexion-extension, a wrist ulnar-radial deviation, a Forearm pronation-supination, a gross hand opening and closing movement, an instrumented hand opening-closing, a tripod pinch, a thumb flexion-extension, a Finger stretching and Individual finger training mechanism. The various therapy tools (500) and the operation are further described in the FIGS. 5A-12B. Therefore, the modular and portable plug-and-train robot (1000) provides a high degree of modularity which enables the user to be trained in any of the wrist movements and hand movements. Also, since the therapy tools (500) is externally attached to the modular and portable plug-and-train robot (1000), the therapy tools (500) may be modified, used for treating other parts of the body, etc. by attaching to the modular and portable plug-and-train robot (1000).

In another example, the therapy tool (500) may be first attached to the hand of the user and then the therapy tool (500) is connected to an intermediate base which is connected to the plug-in apparatus (400) as a result increasing the modularity and usability of therapy tool and the robot.

In an embodiment, the instrumented armrest (600) is connected to the housing (100) for measuring compensatory forces applied by a forearm of the user while providing the training for the hand rehabilitation at the wrist or the palm portion of the hand. The instrumented armrest (600) is provided with a first force transducer placed on a bottom portion of the instrumented armrest (600) to measure the vertical forces applied by the forearm of the user. The instrumented armrest (600) is also provided with a second force transducer placed on a left portion and a right portion to measure the lateral forces applied by the forearm of the user. During early stages of the hand rehabilitation the user tends to apply more compensatory forces by the forearm to bring about the activity being performed by the therapy tools (500). However, the compensatory forces by the forearm need to be reduced and eliminated overall to enable successful hand rehabilitation. The quantified compensatory forces applied by the forearm of the user may be provided as a feedback to the user to bring about corrections in real-time.

The memory (800) is used to store the measured compensatory forces applied by the forearm of the user over a period of time. Further, the memory (800) may include multiple user profiles storing the feedbacks of multiple users undergoing the hand rehabilitation. Further, the information related to the particular user may be used by medical practitioners for learning which may include but not be limited to plan the therapy for the user, understanding an improvement in medical condition of the user, etc. The memory (800) can include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (800) may, in some examples, be considered a non-transitory storage medium. The term “non-transitory” may indicate that the storage medium is not embodied in a carrier wave or a propagated signal. However, the term “non-transitory” should not be interpreted that the memory (800) is non-movable. In certain examples, a non-transitory storage medium may store data that can, over time, change (e.g., in Random Access Memory (RAM) or cache).

The processor (700) may include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor (700) may include multiple cores and is configured to execute the instructions stored in the memory (800).

Although the FIG. 1 shows the hardware elements of the modular and portable plug-and-train robot (1000) but it is to be understood that other embodiments are not limited thereon. In other embodiments, the modular and portable plug-and-train robot (1000) may include less or more number of elements. Further, the labels or names of the elements are used only for illustrative purpose and does not limit the scope of the invention. One or more components can be combined together to perform same or substantially similar function.

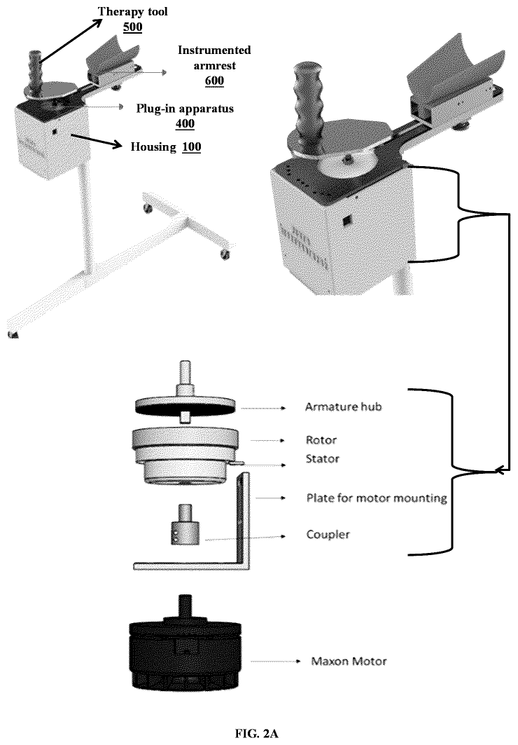

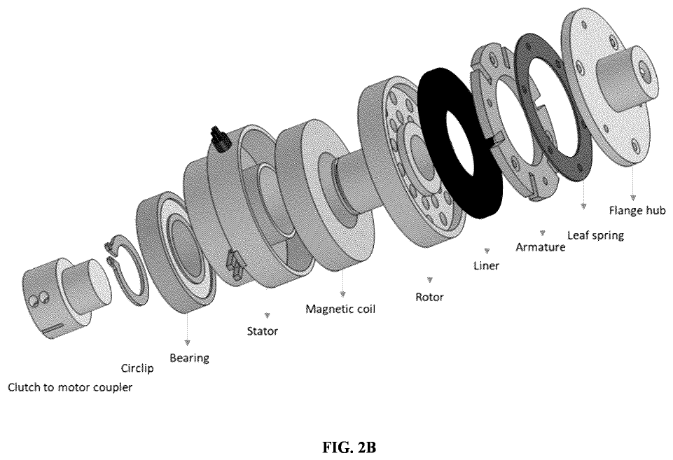

FIG. 2A is a tabletop design of the modular and portable plug-and-train robot (1000) for providing the hand rehabilitation with electromagnetic clutch as the plug-in apparatus (400), according to the embodiments as disclosed herein.

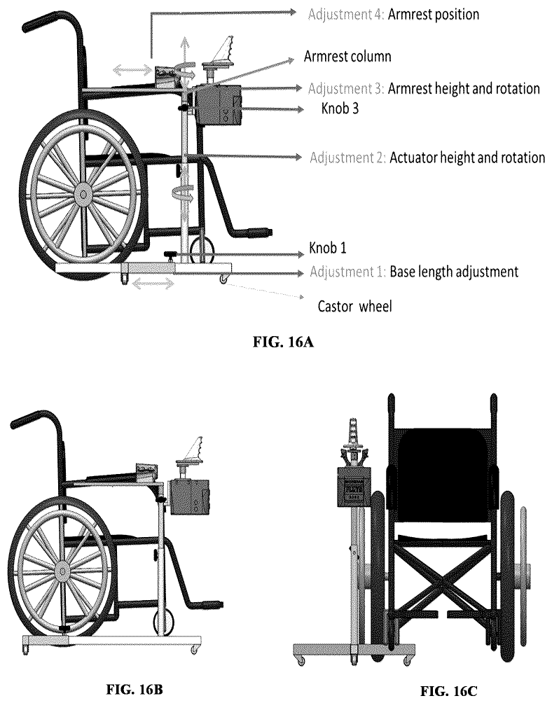

Referring to the FIG. 2A, the tabletop design of the modular and portable plug-and-train robot (1000) for providing the hand rehabilitation with electromagnetic clutch as the plug-in apparatus (400) is provided. The modular and portable plug-and-train robot (1000) includes a column with a cross-shaped base which ensures that the modular and portable plug-and-train robot (1000) does not vibrate while providing the therapy to the hand. Further, the cross-shaped base includes plurality of wheels to enable motion of the modular and portable plug-and-train robot (1000) close to the user to provide the therapy. However, once the position of the modular and portable plug-and-train robot (1000) is fixed with respect to the user, the wheels are locked in place during the therapy to avoid movement of the modular and portable plug-and-train robot (1000) during the therapy. The column is an adjustable column which allows the user to vary the height of the modular and portable plug-and-train robot (1000) based on user requirement and a position of the user. The modular and portable plug-and-train robot (1000) can be positioned next to the human/subject/user to which the therapy is to be provided (further described in FIGS. 16A-16C).

Further, the electromagnetic clutch includes a bearing mounted rotor assembly to which the actuator (300) is coupled through an L-plate where the electromagnetic clutch is attached to the frame with an L-camp with the anti-rotation pin. The actuator (300) includes the hall sensor to measure a speed of the actuator and an encoder to measure an angular position of the actuator is attached to a bottom portion of the L-plate. The bearing mounted rotor assembly is magnetically coupled to the armature hub of the therapy tool (500) to transfer a rotation of the actuator (300) to operate the therapy tool (500). The advantage of the electromagnetic clutch is electrical operation and would not need any manual fastening, thus increasing an ease of usage of the modular and portable plug-and-train robot (1000).

Further, the actuator current is sensed and is used to estimate the torque applied by the motor. The tabletop/housing (100) on which the therapy tools (500) are mounted contains a circular opening (in front of the instrumented armrest (600) for coupling the therapy tool (500) with the motor. Right below the circular opening, there is the L-shaped plate that is attached to the bottom surface of the housing (100). The motor, along with the optical encoder and the Hall sensor, is attached to the bottom of the L-plate.

FIG. 2B illustrates an assembly of the electromagnetic clutch as the plug-in apparatus (400) of the modular and portable plug-and-train robot (1000), according to the embodiments as disclosed herein.

Referring to the FIG. 2B, shows the exploded view of the assembly of the electromagnetic clutch. The electromagnetic clutch has a bearing mounted rotor to which the motor is coupled through an electromagnetic clutch-motor coupler. Thus, the rotation of the motor is transferred to the rotor. Each of the therapy tools (500) include the armature hub that attach to the rotor of the electromagnetic clutch. The rotor of the electromagnetic clutch and the armature hub of the therapy tool (500) are magnetically coupled to transfer the motor rotation to the therapy tool (500).

The push-button-operated electromagnetic clutch helps the patient to change between the different therapy tools (500) without the need for fasteners. The electromagnetic clutch couples a therapy tool (500) with the motor when a magnetic coil of the modular and portable plug-and-train robot (1000) is powered on and the therapy tool (500) is uncoupled when the magnetic coil of the modular and portable plug-and-train robot (1000) is powered off. When the magnetic coil of rotor of the electromagnetic clutch is energized, the magnetic field of the magnetic coil pulls the armature plate on to the rotor, establishing a mechanical connection through friction. The friction force between the rotor and the armature hub transmits torque from the motor to the therapy tool (500). The friction liner on the rotor increases the torque transmission between the armature (which is the plug-in apparatus (400)) and the motor. To disengage the therapy tool (500), the electrical power to the magnetic coil of the modular and portable plug-and-train robot (1000) is switched off. With no magnetic field affecting the armature, the armature is pulled back into the default position by a flat spring. As a result, the therapy tool (500) can be easily removed from the modular and portable plug-and-train robot (1000) without much effort.

FIG. 2C illustrates a torque characterization setup of the electromagnetic clutch, according to the embodiments as disclosed herein. Referring to the FIG. 2C, to quantify the torque the electromagnetic clutch can transmit without any slip the torque characterization setup is used. Various current and voltage values are set in the electromagnetic clutch and a slipping torque is recorded. The slipping torque is a maximum torque the electromagnetic clutch can transmit without any slip between the rotor and the armature hub. The electromagnetic clutch can transmit up to a 12.75 Nm torque at 24v and 0.700 A and 4.75N at 12V and 0.330 A. However, when using the electromagnetic clutch at 24V the coil temperature becomes high, so a 12V and 0.34 A supply is used. The electromagnetic clutch rated torque is well above the motors rated torque of 1.2 Nm, and most of the rehabilitation training happens less than 1.5 Nm. Hence, a factor of safety of ˜3.5 is used while using the electromagnetic clutch as the plug-in apparatus (400) of the modular and portable plug-and-train robot (1000).

FIG. 2D illustrates a surface temperature of the electromagnetic clutch, according to the embodiments as disclosed herein.

Referring to the FIG. 2D, the use of electromagnetic clutch as the plug-in apparatus (400) increases the use of attachment and detachment of the therapy tool (500) without requirement of screwing-in of the therapy tool (500). However, one of the main disadvantages of using the electromagnetic clutch is that a large amount of heat is generated during long-term use. To check the temperature of the electromagnetic clutch, the electromagnetic clutch is powered with a desired operating voltage of 12V and 300 mA. Further, a calibrated thermocouple is used to continuously measure the temperature on the surface of the electromagnetic clutch for 2 hours and the FIG. 2D illustrates the temperature of the surface across different time points on the electromagnetic clutch. The surface temperature of the electromagnetic clutch is initially at the ambient temperature of ˜32° C. which is slowly increased to 38° C. after 1 hour. The temperature is later plateaus and stays below 39° C. the same temperature for the rest of the time. The therapy tool (500) where the patient's hand would be placed will not be affected by a small raise in temperature as the therapy tool (500) is provided with portions which are insulators.

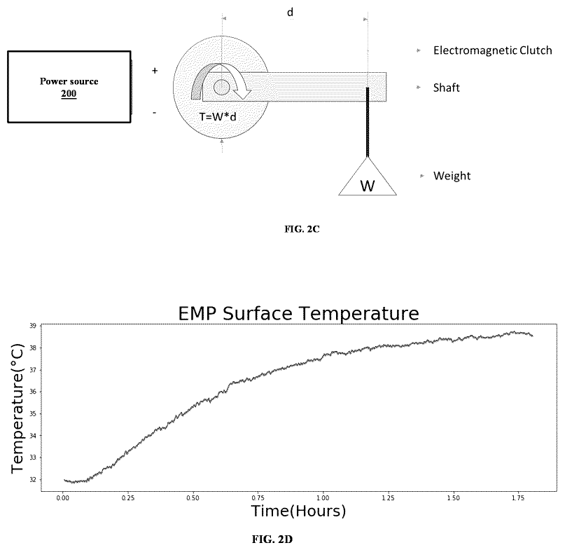

FIG. 3 illustrates an assembly of the mechanical shutter lock as plug-in apparatus (400) of the modular and portable plug-and-train robot (1000), according to the embodiments as disclosed herein.

Referring to the FIG. 3, the mechanical shutter lock is a non-powered alternative to be used as the plug-in apparatus (400) in the modular and portable plug-and-train robot (1000). The mechanical shutter lock has three parts: a motor shaft coupler, plunger of the therapy tool (500), and lock-pin. When the mechanical shutter lock is used as the plug-in apparatus (400), then all the therapy tool (500) are provided with the plunger. The lock pin has a profile matched with the plunger of the therapy tool (500) that allows a ratchet motion between the plunger of the therapy tool (500) and the lock pin.

The spring pushes the lock-in against the plunger of the therapy tool (500), allowing the plunger to be only pushed in, and stops the plunger from moving up. This couples the therapy tool (500) with the motor shaft and the coupler's rotation would lead to the rotation of the therapy tool (500). To decouple the therapy tool (500), the lock pin is pressed/pushed in, and the spring is compressed the plunger becomes free to move and can be pulled out to detach the therapy tool (500). Various views of the mechanical shutter lock in locked position and open position are provided in the FIG. 3 elaborating the role of the lock pin and the spring.

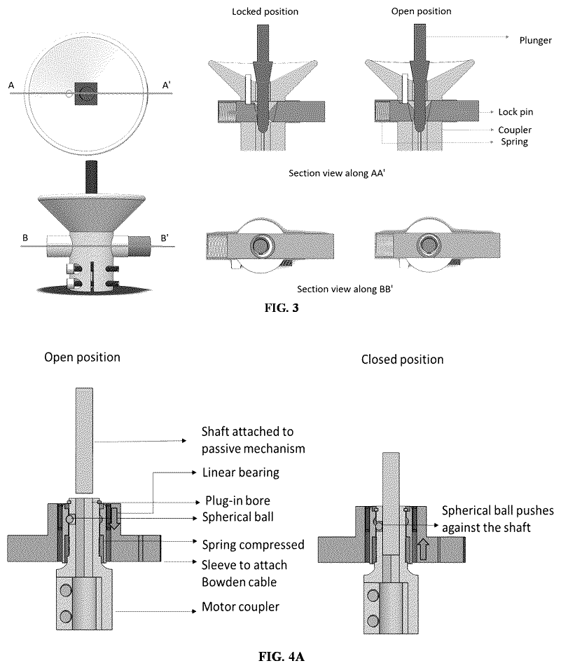

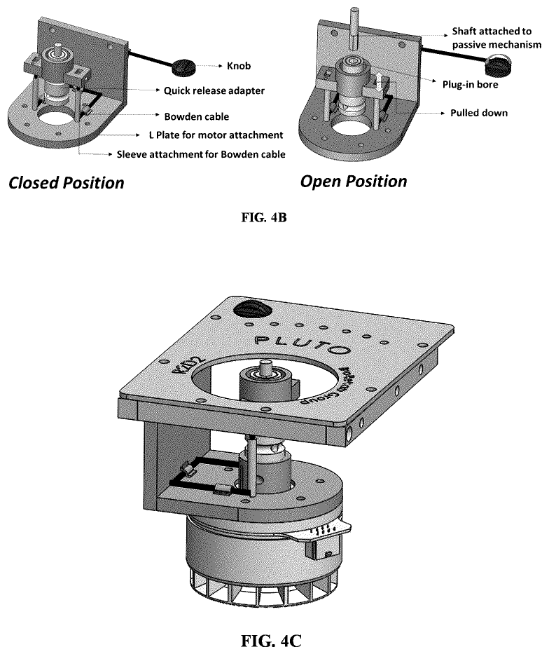

FIGS. 4A-4B illustrates an assembly of the Bowden cable as plug-in apparatus (400) of the modular and portable plug-and-train robot (1000), according to the embodiments as disclosed herein.

Referring to the FIG. 4A, in another example the plug-in apparatus (400) used is the Bowden cable. The Bowden cable plug-in is a non-actuated plug-in apparatus (400), where a push-pull Bowden cable is used for attaching and detaching the therapy tool (500). The therapy tool (500) needs to have a square shaft end locked by a spring-ball lock, as shown in the FIG. 4A.

When an outer sleeve is in a top position, the square face of the shaft is pushed against two spherical balls radially creating an interference fit holding the shaft in place. When the Bowden cable is not pulled, the spring ensures that the outer sleeve is always pushed up and stays in the top position (locked). Therefore, in the closed position, the spherical ball pushed against the shaft creates the interference between the plug-in bore and the square shaft of the therapy tool (500).

To release the therapy tool (500), the Bowden cable is pulled by turning the knob (as shown in the FIG. 4B). As the Bowden cable length shortens, the outer sleeve is pulled down by compressing the spring. When the outer sleeve is moved down, the spherical balls move radially outward, creating a clearance fit between the square shaft and plug-in bore. This makes the therapy tool (500) detachable.

FIG. 4C illustrates the assembly of the Bowden with the motor of the modular and portable plug-and-train robot (1000), according to the embodiments as disclosed herein.

Referring to the FIG. 4C, the assembly of the plug-in mechanism with the motor of the modular and portable plug-and-train robot (1000) is provided. The motor coupler attaches to the motor shaft which is mounted on the L-plate. The Bowden cable is routed through a sleeve that is fixed with the motor L-plate and attaching the plug-in mechanism to the L-plate.

FIG. 5A and FIG. 5B are examples of attaching the therapy tools (500) used to provide the wrist flexion-extension and wrist ulnar-radial deviation mechanism hand rehabilitation using the electromagnetic clutch and mechanical shutter lock respectively, to the modular and portable plug-and-train robot (1000), according to the embodiments as disclosed herein.

The modular and portable plug-and-train robot (1000) uses a single actuator (300) with an open/free output shaft. The therapy tools (500) without any sensors or electronics to provide the single-DOF mechanisms can be attached easily for training different wrist and hand functions to the modular and portable plug-and-train robot (1000). The therapy tool (500) determines the function to be trained with the modular and portable plug-and-train robot (1000). The modular and portable plug-and-train robot (1000) can train the following functions but are not limited to the same:
1. Wrist flexion-extension
2. Wrist ulnar-radial deviation
3. Forearm pronation-supination
4. Gross hand opening and closing
5. Instrumented hand opening-closing
6. Tripod pinch
7. Thumb flexion-extension
8. Finger stretching
9. Individual finger training mechanism (MCP or PIP).

Referring to the FIG. 5A, the therapy tools (500) used to provide the wrist flexion-extension and wrist ulnar-radial deviation hand rehabilitation are attached to the modular and portable plug-and-train robot (1000) using the electromagnetic clutch.

The therapy tool (500) used for providing the wrist flexion-extension hand rehabilitation includes a handle to hold the user's hand. The handle is attached to a linear guide and carriage to account for an offset between the axis of rotation of the human wrist and that of the actuator (300). Further, the armature hub acts as the intermediate layer between the therapy tool (500) and the actuator (300). The handle of the therapy tool (500) is custom 3D printed as per the user requirements.

The construction of the therapy tool (500) used for providing the wrist ulnar-radial deviation is the same as the therapy tool (500) used for wrist flexion and extension except for a change in the shape of the handle.

Referring to the FIG. 5B, the armature hub of the therapy tool (500) is replaced with the plunger pin to couple with the mechanical shutter lock. However, the operation is same as FIG. 5A and hence repeated description is omitted.

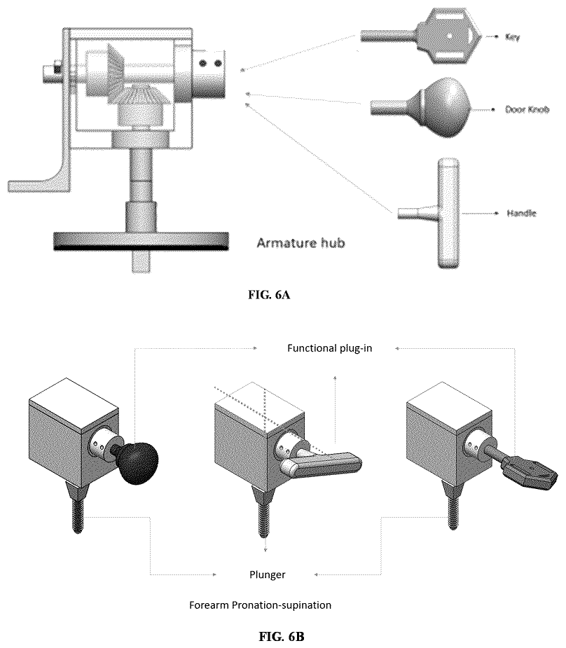

FIG. 6A and FIG. 6B are an examples of attaching the therapy tool (500) used to provide the forearm pronation-supination hand rehabilitation using the electromagnetic clutch and the mechanical shutter lock respectively, to the modular and portable plug-and-train robot (1000), according to the embodiments as disclosed herein.

Referring to the FIG. 6A, the Forearm Pronation-Supination (FPS) therapy tool (500) uses a 1:1 bevel gear to rotate the rotation axis by 90 degrees. There is additional back support for the FPS therapy tool (500) to prevent the entire therapy tool (500) from rotating. To the therapy tool (500), functional handles like a key, doorknob, steering wheel can be added to provide functional training.

Referring to the FIG. 6B, the armature hub of the therapy tool (500) is replaced with the plunger pin to couple with the mechanical shutter lock. However, the operation is same as FIG. 6A and hence repeated description is omitted.

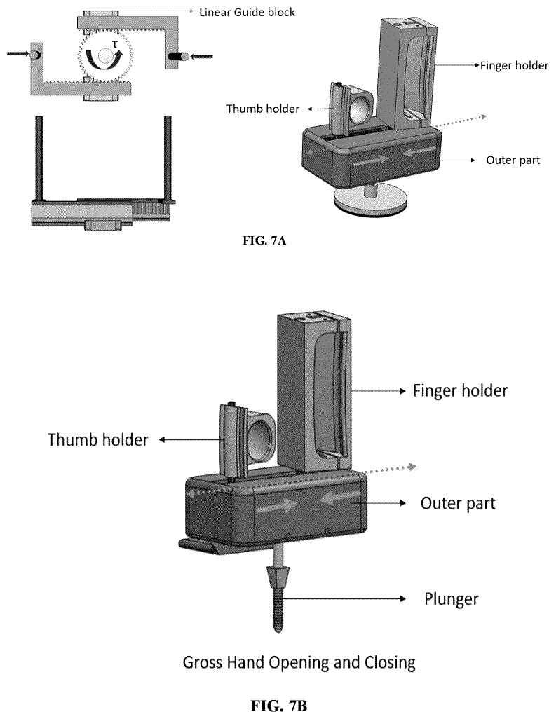

FIG. 7A and FIG. 7B are an example of attaching the therapy tool (500) used to provide the Gross hand opening-closing hand rehabilitation using the electromagnetic clutch and the mechanical shutter lock respectively, to the modular and portable plug-and-train robot (1000), according to the embodiments as disclosed herein.

Referring to the FIG. 7A, the therapy tool (500) converts the rotary motion of the motor to translational motion that is used for opening and closing of the hand. The motion is achieved by using two racks coupling with a single pinion. To prevent the entire therapy tool (500) from rotating the outer part of the box has fixation which prevents rotation. The therapy tool (500) has two holder thumb fingers attached in thumb holder all other finger attached in finger holder. The armature hub is attached to the shaft of the pinion gear.

Referring to the FIG. 7B, the armature hub of the therapy tool (500) is replaced with the plunger pin to couple with the mechanical shutter lock. However, the operation is same as FIG. 7A and hence repeated description is omitted.

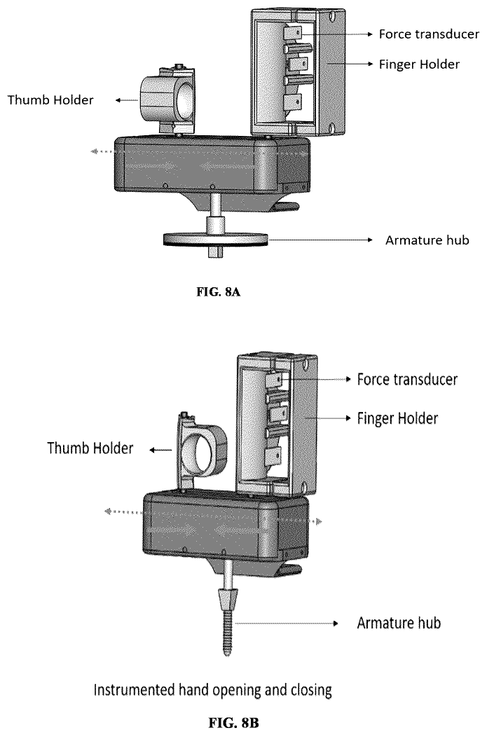

FIG. 8A and FIG. 8B are examples of attaching the therapy tool (500) used to provide the instrumented hand opening closing hand rehabilitation using the electromagnetic clutch and the mechanical shutter lock respectively, to the modular and portable plug-and-train robot (1000), according to the embodiments as disclosed herein.

Referring to the FIG. 8A, the therapy tool (500) used to provide the instrumented hand opening-closing hand rehabilitation is the same as the therapy tool (500) used to provide the gross hand opening-closing hand rehabilitation, with an addition of a force transducer. The force transducer in the therapy tool (500) measures the instructed finger force and other finger force the user is applying during opening and closing of the hand. Referring to the FIG. 8B, the armature hub of the therapy tool (500) is replaced with the plunger pin to couple with the mechanical shutter lock. However, the operation is same as FIG. 8A and hence repeated description is omitted.

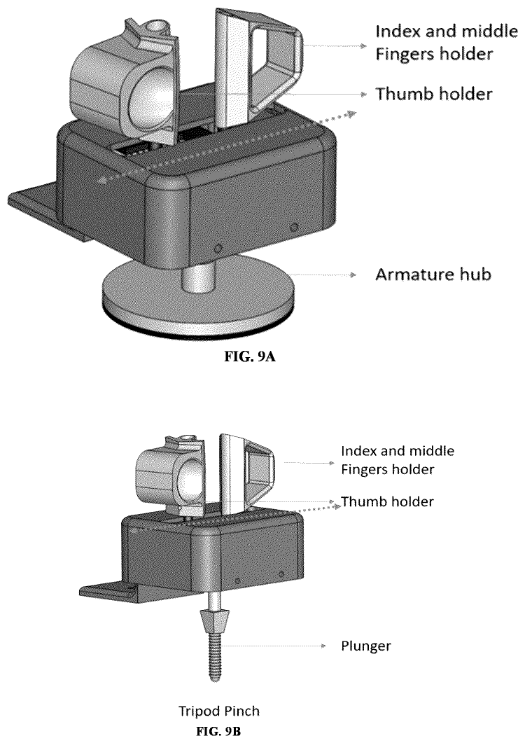

FIG. 9A and FIG. 9B are examples of attaching the therapy tool (500) used to provide the tripod pinch hand rehabilitation using the electromagnetic clutch and the mechanical shutter lock respectively, to the modular and portable plug-and-train robot (1000), according to the embodiments as disclosed herein.

Referring to the FIG. 9A, the therapy tool (500) used to provide the tripod pinch hand rehabilitation has the same design as the therapy tool (500) used to provide the hand opening closing hand rehabilitation as illustrated in the FIG. 9A. However, the finger holder is changed, to hold index and middle finger. Referring to the FIG. 9B, the armature hub of the therapy tool (500) is replaced with the plunger pin to couple with the mechanical shutter lock. However, the operation is same as FIG. 9A and hence repeated description is omitted.

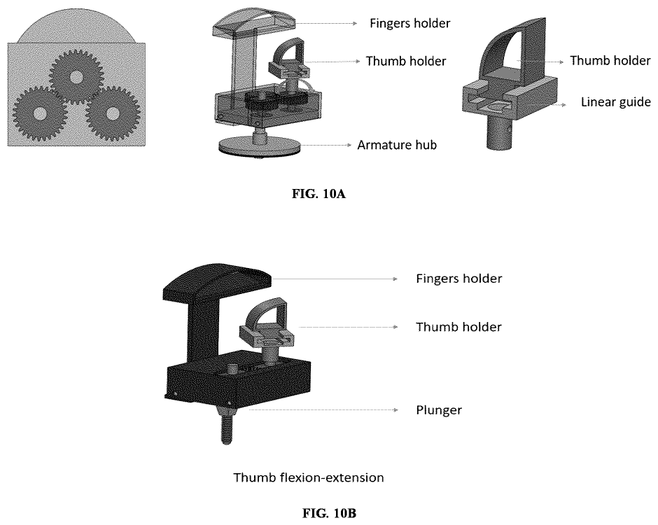

FIG. 10A and FIG. 10B are examples of attaching the therapy tool (500) used to provide the thumb flexion-extension hand rehabilitation using the electromagnetic clutch and the mechanical shutter lock respectively, to the modular and portable plug-and-train robot (1000), according to the embodiments as disclosed herein.

Referring to the FIG. 10A, the therapy tool (500) used to provide the thumb flexion-extension hand rehabilitation is specially designed to train only thumb flexion-extension. The therapy tool (500) used to provide the thumb flexion-extension includes three gears. A center gear is attached actuator/motor, and the other two gears are on either side of the actuator (300). The gear on the sides includes a shaft pinned at the center used for coupling the thumb attachment. The thumb holder coupler is kept at the right gear when training the right thumb finger and to the left gear when training the left thumb. The thumb holder is attached with a linear guide. The armature hub is attached to the center of the pinion. Referring to the FIG. 10B, the armature hub of the therapy tool (500) is replaced with the plunger pin to couple with the mechanical shutter lock. However, the operation is same as FIG. 10A and hence repeated description is omitted.

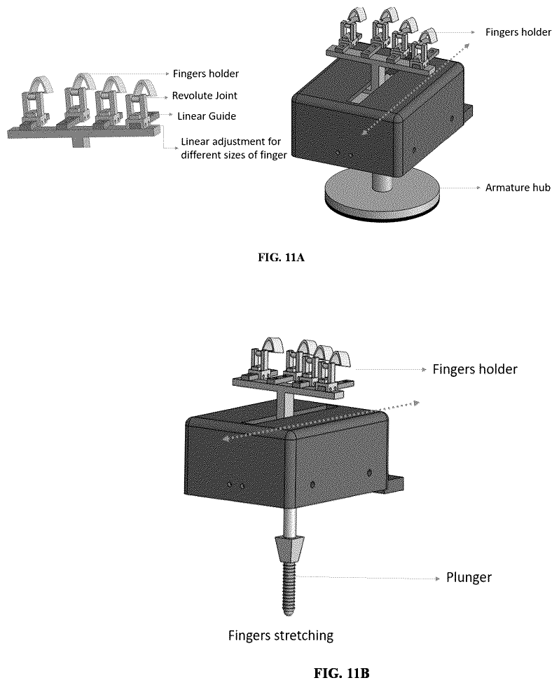

FIG. 11A and FIG. 11B are examples of attaching the therapy tool (500) used to provide the finger stretching hand rehabilitation using the electromagnetic clutch and the mechanical shutter lock respectively, to the modular and portable plug-and-train robot (1000), according to the embodiments as disclosed herein.

Referring to the FIG. 11A, the therapy tool (500) used to provide the finger stretching hand rehabilitation includes four holders to hold four fingers except for the thumb. The therapy tool (500) converts rotary motion into translation by using rack and pinion gear. Each finger holder has a linear rail and carriage base with a lock pin that can be used to adjust to different finger lengths. The finger holder has a revolute joint and hence the finger holder turns along with the finger when stretched. To avoid the entire mechanism from rotating, the outer part is fixed to the tabletop. Referring to the FIG. 11B, the armature hub of the therapy tool (500) is replaced with the plunger pin to couple with the mechanical shutter lock. However, the operation is same as FIG. 11A and hence repeated description is omitted.

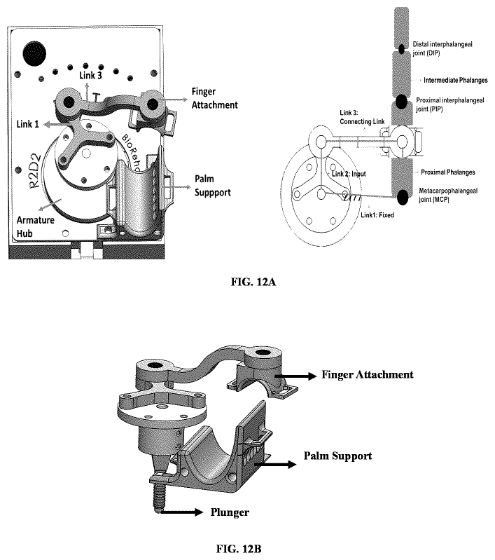

FIG. 12A and FIG. 12B are examples of attaching the therapy tool (500) used to provide the MCP finger stretching hand rehabilitation using the electromagnetic clutch and the mechanical shutter lock respectively, to the modular and portable plug-and-train robot (1000), according to the embodiments as disclosed herein.

Referring to the FIG. 12A, the therapy tool (500) used to provide individual finger flexion-extension training is Revolute-Revolute-Revolute (RRR) linkage with planar links and is fixed to the finger. The therapy tool (500) forms a close 4-bard loop with the finger; the attachment point can be located either at the proximal or the middle segment of the finger. The FIG. 12A illustrates the 4-bar linkage. The finger acts as an output link, and the other two links transfer the robot's torque to the finger joint.

The link lengths are optimized to have a range of motion of 5-130 degrees at the finger and a mean transmission ratio of 1.094 across the range of motion. The therapy tool (500) can train phalanges that vary between 2 cm to 5 cm. The optimized link lengths are Link 1: 5 cm; Link 2: 4 cm; Link 3:8 cm. The palm rest holds the hand to maintain 5 cm between the axis of the modular and portable plug-and-train robot (1000) and the finger joint (Link 1). By fixing the palm and attaching the finger attachment to the proximal phalanges, the mechanism will train the MCP flexion-extension. Similarly, by fixing the MCP joint and attaching link 3 to the intermediate phalanges, the therapy tool (500) can be used to train for Proximal interphalangeal joint (PIP) flexion-extension.

Referring to the FIG. 12B, the armature hub of the therapy tool (500) is replaced with the plunger pin to couple with the mechanical shutter lock. However, the operation is same as FIG. 12A and hence repeated description is omitted.

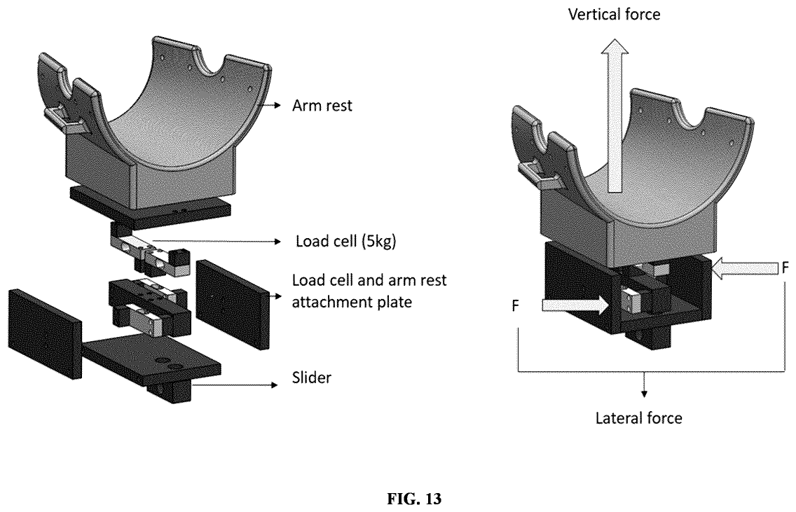

FIG. 13 illustrates the instrumented armrest (600) for determining compensatory forces applied by a forearm of the user during the hand rehabilitation, according to the embodiments as disclosed herein.

Referring to the FIG. 13, the instrumented armrest (600) supports a weight of the forearm and also constrains the compensatory movements of the forearm during training. The instrumented armrest (600) is fit on a plate that encloses load cell assembly to measure vertical forces and lateral forces applied on the instrumented armrest (600). Left and right-side force transducer detect push and pull force (i.e., lateral force), and force transducer placed on the top to measure the forces in the vertical direction. The direction of force and arrangement of force transducer is provided in the FIG. 13.

In an embodiment, a feedback of force may be provided to the patients through a therapy game which the patients may be required to play and thereby ensuring that the user does not apply the compensatory forces of the forearm. Further, the feedback may be stored in the memory (800) and may be used to train the modular and portable plug-and-train robot (1000). Due to the feedback, a real-time correction can be brought about in a behavior of the user during the hand rehabilitation.

In another embodiment, the measured compensatory forces of the forearm can also be used to determine a progress of the patient and also modify the hand rehabilitation appropriately.

FIG. 14 illustrates camera integration to the hand rehabilitation provided by the modular and portable plug-and-train robot (1000), according to the embodiments as disclosed herein.

Referring to the FIG. 14, the camera may be integrated to an electronic device for recording movements of the user each time the user plays a game on the electronic device as part of the hand rehabilitation. The electronic device records a video of the hand along with the game screen which can be later accessed by medical practitioners to know the progress of the user and also to plan future therapy accordingly. Further, feedback determined in the FIG. 13 can be used to modifications to the game to bring about the real-time correction in the behavior of the user during the hand rehabilitation.

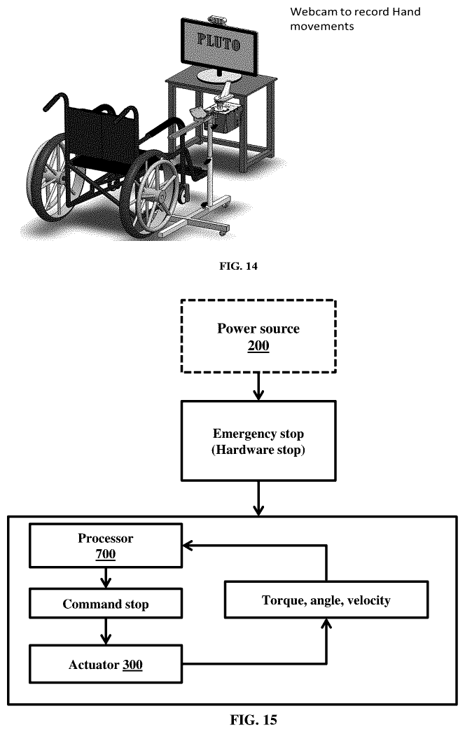

FIG. 15 illustrates an emergency switch incorporated with the modular and portable plug-and-train robot (1000) for providing the hand rehabilitation, according to the embodiments as disclosed herein.

Referring to the FIG. 15, to ensure the safety of the modular and portable plug-and-train robot (1000) various safety measures are provided which includes but not limited to redundant mechanical, electrical and command safety features. The power source (200) is switched off when an emergency switch is pressed, this would cut the supply to both the actuator (300) and the processor (700). The emergency stop button is mounted on a box that can handheld by the user. Further, the actuator (300) is also disabled when command limits on position, velocity, and torque are exceeded by the processor (700).

FIGS. 16A-16C illustrates the trolley design incorporating the modular and portable plug-and-train robot (1000) with a wheelchair, according to the embodiments as disclosed herein.

Referring to the FIG. 16A, the modular and portable plug-and-train robot (1000) is placed next to the wheelchair due to the portability in the trolley design. The trolley has 4 adjustment mechanisms to fit different chairs, wheelchairs, etc. where the user can sit during the hand rehabilitation. All adjustments are held in place by knobs (nut-bolt assembly).

The four adjustments include:
1. The first adjustment changes the wheelbase of the modular and portable plug-and-train robot (1000), to ensure the modular and portable plug-and-train robot (1000) can fit around different chairs/tables. Castor wheels are provided at the ends to move the modular and portable plug-and-train robot (1000) close to the user.
2. The second adjustment allows changing a height and the rotation of both motor and the armrest simultaneously.
3. The third adjustment allows changing the height and rotation of the armrest column independently.
4. The armrest by itself can be translated across the arm-rest column and fixed.

Therefore, the modular and portable plug-and-train robot (1000) due to the portability and modularity can be used to provide hand rehabilitation to the patients at a very early stage of the disability which ensures better recovery rate. Also, the incorporation of the modular and portable plug-and-train robot (1000) to trolley design, etc. ensures that the hand rehabilitation is carried out at the comforts of the patient.

The foregoing description of the specific embodiments will so fully reveal the general nature of the embodiments herein that others can, by applying current knowledge, readily modify or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

We claim:

1. A modular and portable plug-and-train robot (1000) for providing hand rehabilitation, wherein the modular and portable plug-and-train robot (1000) comprising:
a memory (800);
a processor (700) coupled to the memory (700);
a housing (100);
a power source (200) for powering the modular and portable plug-and-train robot (1000) to provide the hand rehabilitation;
an actuator (300) mounted within the housing and connected to the power source (200) for providing movements to the modular and portable plug-and-train robot (1000);
a plug-in apparatus (400) for coupling the actuator (300) and a therapy tool (500), wherein the therapy tool (500) provides a single degree of freedom (DOF) movement to a hand for the hand rehabilitation; and
an instrumented armrest (600) connected to the housing (100) for determining compensatory forces applied by a forearm of the user during the hand rehabilitation.

2. The modular and portable plug-and-train robot (1000) as claimed in claim 1, wherein the actuator (300) is a gearless direct current (DC) motor.

3. The modular and portable plug-and-train robot (1000) as claimed in claim 1, wherein the therapy tool (500) provides training to the hand in order to induce at least one of wrist movements and hand movements.

4. The modular and portable plug-and-train robot (1000) as claimed in claim 1, wherein the therapy tool (500) comprises one of an armature hub (500a) and a plunger (500b) to connect at a top portion of the plug-in apparatus (400).

5. The modular and portable plug-and-train robot (1000) as claimed in claim 1, wherein the plug-in apparatus (400) is one of an electromagnetic clutch, Bowden cable and a mechanical shutter lock, wherein the electromagnetic clutch uses an electromagnetic force to connect the therapy tool (500) to the actuator (300).

6. The modular and portable plug-and-train robot (1000) as claimed in claim 5, wherein the mechanical shutter lock comprises a motor shaft coupler, a spring and a lock-pin, wherein the lock-pin comprises a profile matched with the plunger (500b) of the therapy tool (500).

7. The modular and portable plug-and-train robot (1000) as claimed in claim 6, wherein the spring in the mechanical shutter lock pushes the lock-in against the plunger of the therapy tool (500) to lock the plunger (500b) in a specific position and the locked plunger (500b) couples the therapy tool (500) with the motor shaft coupler of the mechanical shutter lock, wherein the motor shaft coupler rotates and transfers the rotation to the therapy tool (500).

8. The modular and portable plug-and-train robot (1000) as claimed in claim 5, wherein the electromagnetic clutch comprises a bearing mounted rotor assembly to which the actuator (300) is coupled through an L-plate, wherein the actuator (300) is mounted to the L-plate with an anti-rotation pin.

9. The modular and portable plug-and-train robot (1000) as claimed in claim 8, wherein the actuator (300) with a hall sensor to measure a speed of the actuator (300) and an encoder to measure an angular position of the actuator is attached to a bottom portion of the L-plate.

10. The modular and portable plug-and-train robot (1000) as claimed in claim 8, wherein the bearing mounted rotor assembly is magnetically coupled to the armature hub of the therapy tool (500) to transfer a rotation of the actuator (300) to operate the therapy tool (500).

11. The modular and portable plug-and-train robot (1000) as claimed in claim 1, wherein the instrumented armrest (600) is connected to the housing (100) using a plate arrangement and wherein the plate arrangement comprises a load cell assembly to measure the compensatory forces applied on the armrest (600) by the forearm of the user during the hand rehabilitation, wherein the compensatory forces comprises vertical forces and lateral forces.

12. The modular and portable plug-and-train robot (1000) as claimed in claim 11, wherein the instrumented armrest (600) comprises a first force transducer placed on a bottom portion of the instrumented armrest (600) to measure the vertical forces applied by the forearm of the user, and a second force transducer placed on a left portion and a right portion of the instrumented armrest (600) to measure the lateral forces applied by the forearm of the user.

13. The modular and portable plug-and-train robot (1000) as claimed in claim 11, wherein the compensatory forces measured by the instrumented armrest (600) is used for real-time modification of the hand rehabilitation.

14. The modular and portable plug-and-train robot (1000) as claimed in claim 1, wherein the therapy tool (500) is inserted to the hand of the user and connected to an intermediate base, wherein the intermediate base is connected to the plug-in apparatus (400).

15. The modular and portable plug-and-train robot (1000) as claimed in claim 3, wherein the wrist movements and hand movements comprises at least one of a wrist flexion-extension, a wrist ulnar-radial deviation, a Forearm pronation-supination, a gross hand opening and closing movement, an instrumented hand opening-closing, a tripod pinch, a thumb flexion-extension, a Finger stretching and Individual finger flexion-extension and abduction-adduction training mechanism.
